(19) United States
(12) Patent Application Publication
(10) Pub. No.: US 2016/0019571 A1
(43) Pub. Date: Jan. 21, 2016

(54) METHOD AND SYSTEM FOR IMPROVED ONLINE AUCTION

(71) Applicants: Mark RIVAS, Fairfax, VA (US); Ryan Rivas, East Meadow, NY (US); Rene Rivas, Sunnyside, NY (US)

(72) Inventors: Mark RIVAS, Fairfax, VA (US); Ryan Rivas, East Meadow, NY (US); Rene Rivas, Sunnyside, NY (US)

(21) Appl. No.: 14/745,809

(22) Filed: Jun. 22, 2015

Related U.S. Application Data
(60) Provisional application No. 62/015,199, filed on Jun. 20, 2014.

(51) Int. Cl. G06Q 30/02; G06Q 30/08

(52) U.S. Cl. CPC G06Q 30/0209; G06Q 30/08

(57) ABSTRACT

A method and system for an improved online auction is provided. The improved online auction fosters a win-win scenario and a sense of fairness between buyers and sellers, whereby the participants know the exact dollar cost to complete the auction process within a predictable timeframe. Auction participants know the entirety of their monetary investment in completing an auction—a registration fee. The present invention is adapted so that such participants can earn bidding units as a function of their skill in playing online games with other participants. Wherein, bidding units are used to buy the auctioned item, thereby fostering a non-dollar based competitive nature that attracts some users to auctions, yet maintaining a sense of level-field fairness so as to not repel other users. Moreover, the present invention is also adapted to limit each auction to a predetermined number of participants, each with a limited amount of bidding units, and operating under known time constraints, thereby providing a predictable timeframe for completing each auction process.

### CROSS-REFERENCE TO RELATED APPLICATION

This application claims the benefit of priority of U.S. provisional application Ser. No. 62/015,199 filed 20 Jun. 2014, the contents of which are herein incorporated by reference.

### BACKGROUND OF THE INVENTION

The present invention relates to online auctions and, more particularly, to a method and system for an improved online auction fostering a win-win scenario and a sense of fairness between buyers and sellers, whereby the participants know the exact dollar cost to complete the auction process within a predictable timeframe.

Auctions offer sellers the benefit of price competition among buyers, creating markets for goods and services for which it is normally difficult to set prices. Online auctions have become a fixture of electronic commerce. Auctions offer buyers the possibility of finding specialized goods and services, antiques, used items, and other items that can be difficult to find in conventional stores or in other electronic commerce storefronts. Because prices are not fixed, theory dictates buyers can also obtain some items at significant discounts to retail list prices. On the flip side, sellers can sell some items in excess of the retail list prices because of the potential captured demand and their competitive bidding.

However, buyers on online auctions face the difficulty of determining the actual cost of some items, while the seller faces the concern of selling some items too far below retail list prices. As a result, existing online auctions face the difficulty of a backlash from buyers who may feel deceived into thinking that the auctioned item they have won is deeply discounted, and sellers who are adverse to losing money.

For example, current online auction cost structures are designed to make the bidder think they are paying pennies on the dollar, when in reality in a good number of cases they are paying, if not close to the retail price, more than the actual cost of the auctioned item. There could be endless amounts of bidders coming in and out of an auction before the item is won. In most cases it takes many hours of endless bidding with no real way of knowing if you have a chance at the item. It takes patience and perseverance to have a chance at winning some item, all lending itself to pent-up frustration.

Moreover, a large number of auction sites force the bidder to buy large amounts of bids just to be able to register for their auction. This gives potential buyers pause as to whether they should invest in an auction or not. The initial investment is significant, and the ultimate investment required to win is not known until the auction is completed. Also, it takes hours of bidding to actually have a chance at winning the auction item, many bidder can join the auction at any time and keep the auction moving, until fatigue sets in and the last participant is left to win the item.

Not knowing how much it will cost to win at an online auction, is the prevailing problem all current online auction bidders face. The second problem is sellers fearful of losing money. A third concern is that the bidders don't know how long it will take to win the item.

As can be seen, there is a need for a method and system for an improved online auction fostering a win-win scenario and a sense of fairness between buyers and sellers, whereby the participants know the exact dollar cost to complete the auction process within a predictable timeframe.

### SUMMARY OF THE INVENTION

In one aspect of the present invention, a system for providing an online auction includes a computer having a user interface; and a program product comprising machine-readable program code for causing, when executed, the computer to perform the following process steps: prompting a seller to set auction parameters for the online auction via the user interface, wherein the auction parameters include: at least one auction item; a minimum selling price for each auction item; and a limited number of bidders; producing an electronic representation of an auction hall corresponding to each auction item, wherein the auction hall is configured to provide a bidding system; prompting a plurality of bidders to each pay a registration fee for a predetermined auction item; setting a scoring format for at least one online game; prompting the plurality of bidders to play the at least one online game; rewarding bidding units to the plurality of bidders based at least in part on the scoring format; and electronically interconnecting the plurality of bidders and the auction hall for said predetermined auction item, wherein the bidding system for said predetermined auction item is based on the bidding units rewarded for playing the online game.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention;

FIG. 2 is a continuation of FIG. 1;

FIG. 3 is a screen display of an exemplary embodiment of a login page of the present invention;

FIG. 4 is a screen display of an exemplary embodiment of a game room page of the present invention; and

FIG. 5 is a screen display of an exemplary embodiment of an auction room page of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method and system for an improved online auction fostering a win-win scenario and a sense of fairness between buyers and sellers, whereby the participants know the exact dollar cost to complete the auction process within a predictable timeframe.

In the present invention, auction participants know the entirety of their monetary investment in completing an auction - a registration fee. The present invention is adapted so that such participants can earn bidding units as a function of their skill in playing online games with other participants. Wherein, bidding units are used to buy the auctioned item, thereby fostering a non-dollar based competitive nature that attracts some users to auctions, yet maintaining a sense of level-field fairness so as to not repel other users. Moreover, the present invention is also adapted to limit each auction to a predetermined number of participants, each with a limited amount of bidding units, and operating under known time constraints, thereby providing a predictable timeframe for completing each auction process.

The present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

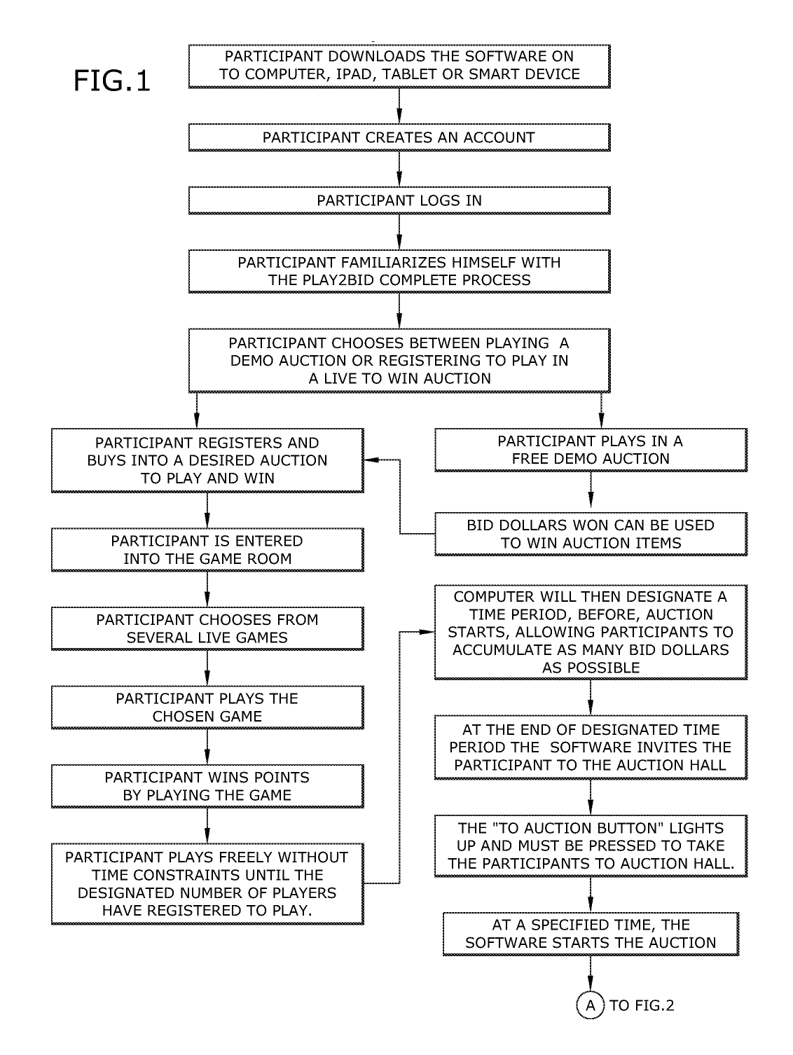

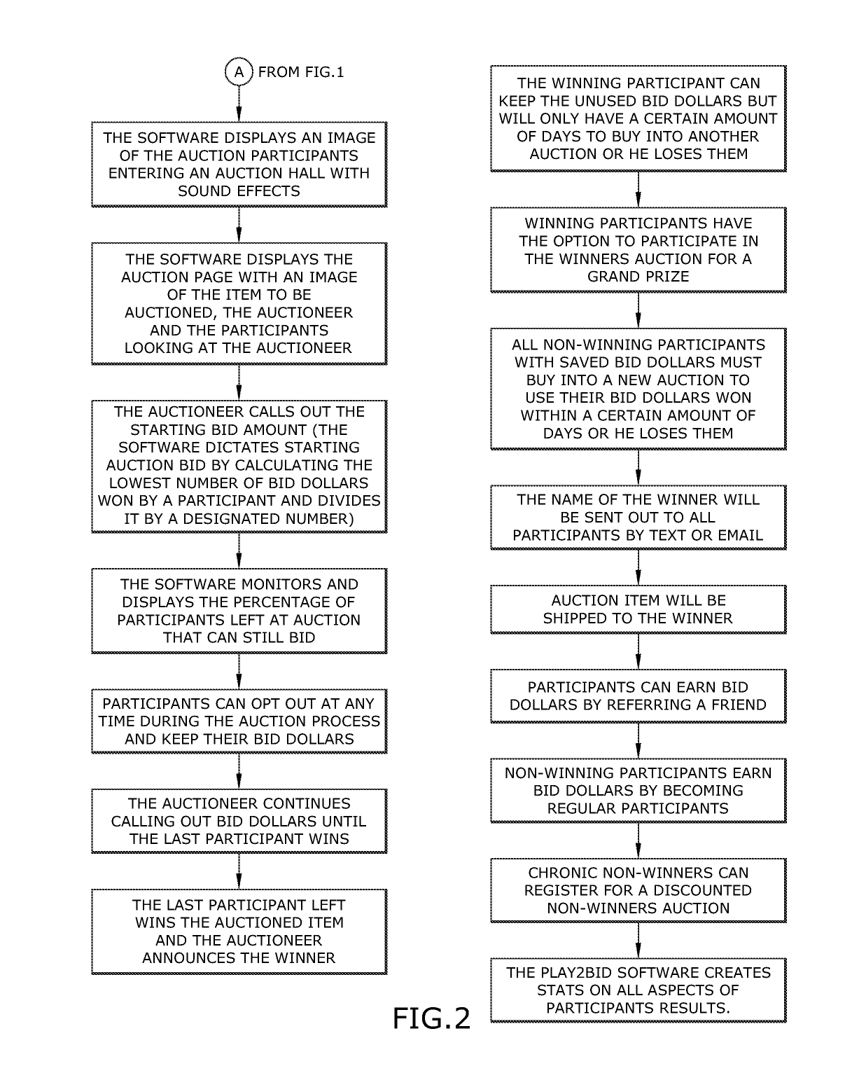

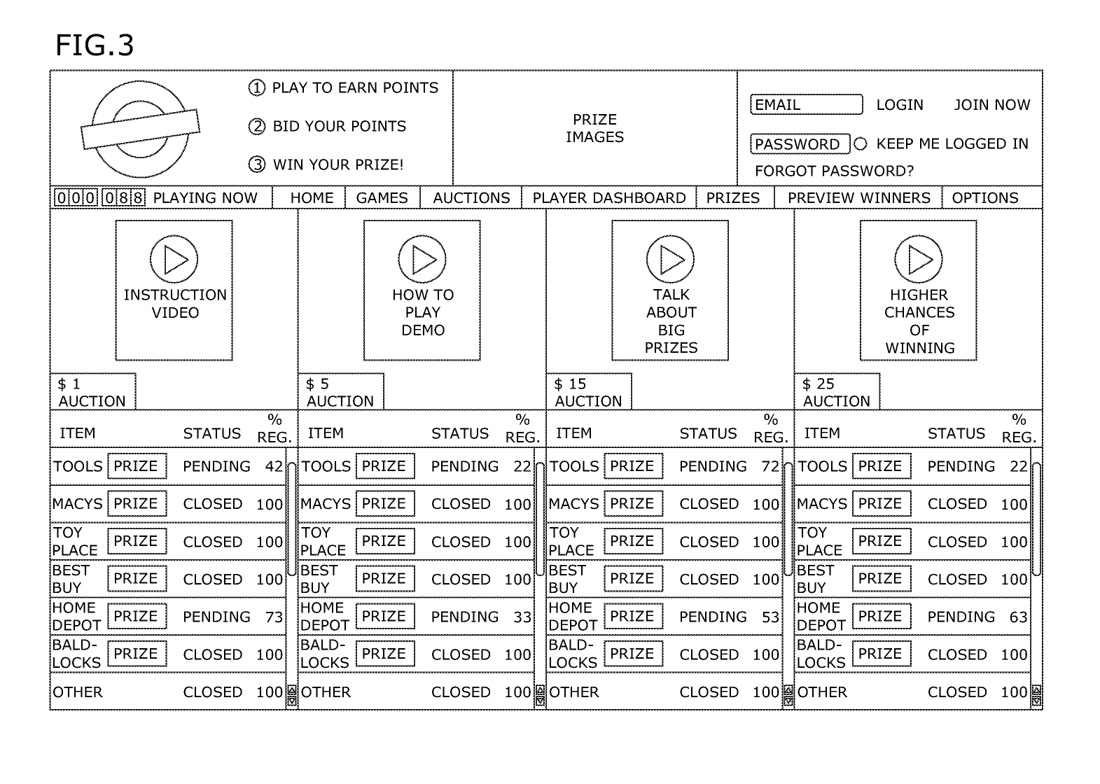

Referring to FIGS. 1 and 2, through the user interface, each participant may create an account to be able to log into the present invention via an electronic login screen produced on the user interface, as illustrated in FIG. 3. Once logged in, each participant can choose between being a seller or a buyer.

The seller is enabled by the present invention to set up at least one predetermined auction having various auction parameters, such as the date of the auction, a minimum selling price for each auction item, a profit margin, a limited number of buyers for each predetermined auction, certain time constraints and the like.

Newly logged-in buyers may be prompted by the present invention to choose between playing in a demo auction or registering for at least one actual live predetermined auction to play and bid against other buyers for auctioned items. Each buyer may choose to play in the demo auction in order to become familiar with the functionality of the actual live predetermined auctions, such as the registration, game playing, bidding unit conversion, the bidding process, time constraints, and other auction processes, at no cost or risk. Typically there will be no carry-over between the demo and the live auctions. However, in certain embodiments, the bidding units won in a demo auction can be used in the live auctions to win auctioned items for new participants, once per participant.

Once familiar with the predetermined games and the auction process, each buyer can register to be able to play and win auctioned items by registering into the at least one predetermined auction of his choosing. Each registration is accompanied by a registration fee. The registration fee is determined by adding the profit margin to the minimum selling price, and then dividing by the limited number of buyers.

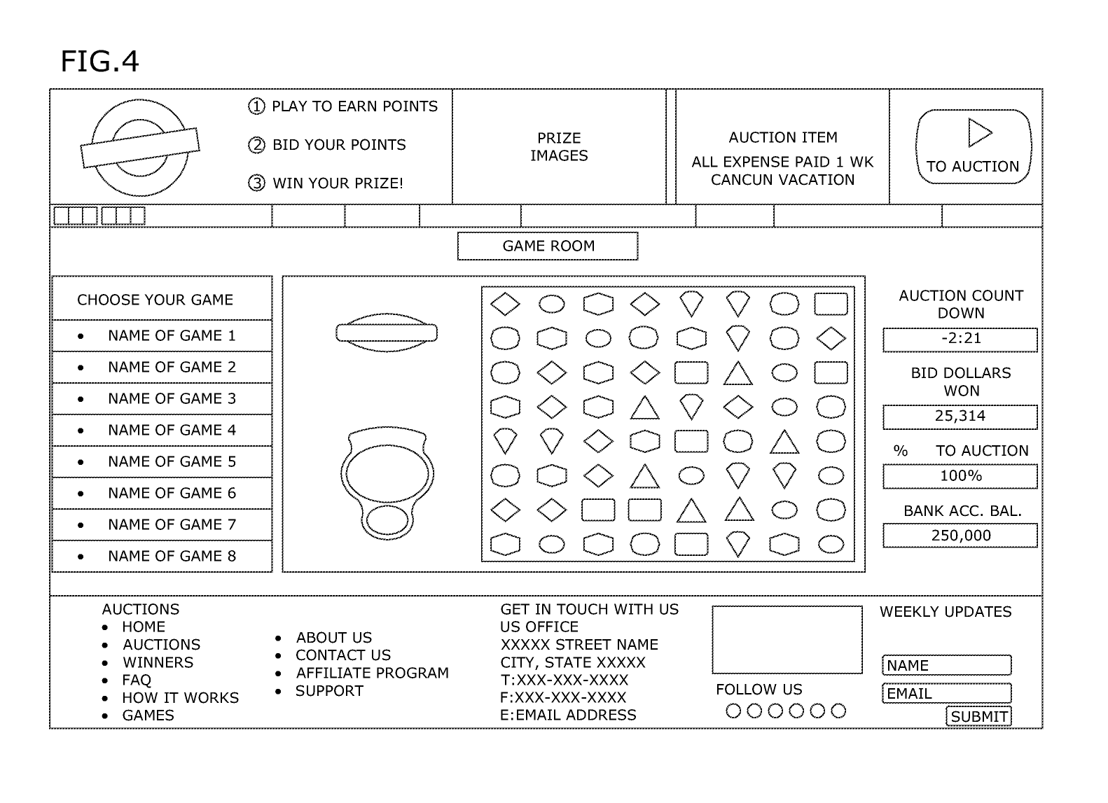

Once registered, the present invention may provide a skills portion, wherein each buyer may enter an electronic games room displayed on the user interface, as illustrated in FIG. 4. During the skills portion, each buyer can choose from multiple games to play, winning bidding units that can be used at the predetermined auction. In certain embodiments, the present invention may grant points for the games played that are later converted to bidding units.

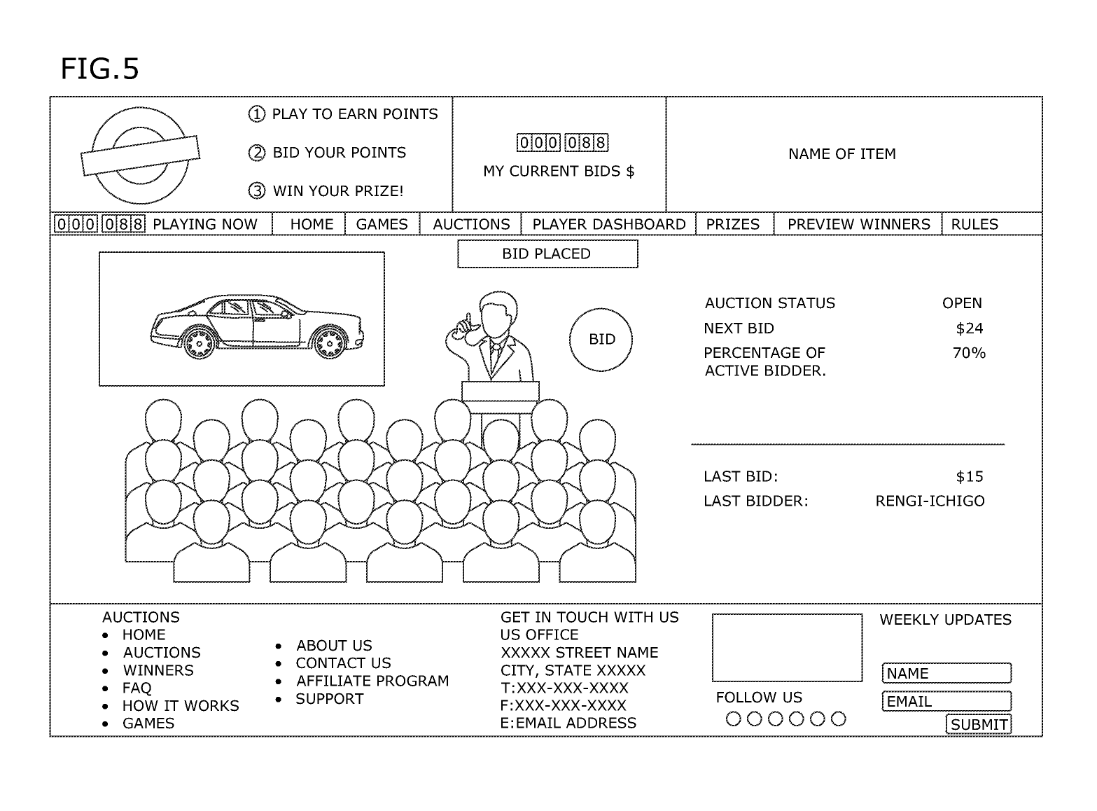

Once a predetermined number of buyers have registered, at least one predetermined auction is activated, preventing any more buyers from registering thereto. Each predetermined auction can be found within a virtual auction hall, as illustrated in FIG. 5, accessible on the user interface. The present invention may establish an auction countdown, and electronically present a countdown clock on the user interface to count down to the beginning of the predetermined auction. The auction countdown can be as short or as long of a predetermined time, as the seller prefers when setting up their auction parameters. Buyers are allowed to play as much as they want at this stage to accumulate as many bidding units as possible within the auction countdown. At the end of the auction countdown, the present invention shuts down the game play and invites the buyers to the auction hall to start the auction bidding process. The electronically interconnecting of the plurality of players and the auction hall auction may happen after the auction countdown lapses, wherein the auction countdown initiates after the producing of the electronic representation of the auction hall. The present invention may provide a start-up time, enabling buyers enough time to get to the auction hall before the auction process begins. This start-up time will be designated by the seller when setting up their auction parameters. The electronically interconnecting of the plurality of players and the auction hall auction may happen after the start-up time lapses, wherein the start-up time initiates when the limited number of bidders are prompted to play the at least one online game.

At the start of each predetermined auction the present invention may display images on the user interface of the auction buyers entering the electronic auction hall and, in certain embodiments, with sound effects. The auction environment page with an image of auction item, image of an auctioneer, and image of the buyers looking at the auctioneer may also be displayed on the user interface.

In certain embodiments, each auction bidding process may be started by the auctioneer welcoming the buyers to the auction and then calling out a minimum starting bid. The present invention may calculate the minimum starting bid (of bidding units) by taking the lowest number of bidding units won by a buyer during the skills portion and dividing it by a predetermined number, including but not limited to the number one. The auctioneer portion of the present invention is adapted to call out each proper bid from the registered buyers, and then implement an allotted bid time before the auction bidding process and thus the predetermined auction ends with the last proper bid being the winning bid. The allotted bid time may be established by the seller when setting up the auction parameters or by the user of the present invention.

During the auction bidding process, the present invention monitors and displays the percentage (%) of buyers left that can still bid after each call within the allotted bid time. During the auction bidding process, any buyer that feels they are not going to win can opt out of the predetermined auction and maintain their bidding units for a future auction. The auctioneer continues to call out bid amounts until the last buyer is left standing and wins the auction. At the end of the auction the auctioneer will announce and display the name of the winning buyer. The winning buyer can keep unused bidding units but will only have a certain amount of days to buy-in to another auction or he loses his saved bidding units.

In certain embodiments, winning buyers may have an opportunity to register for a winner's auction to play and bid for a grand prize. The number of winning buyers that will encompass the auction will be determined by the user. They may get an opportunity to register at a low registration fee, but may bid on a large valuable item, to be determined. All non-winning buyers with accumulated bidding units may buy into a new auction within a designated amount of time to be able to use the pre-existing bidding units. The name of the winning buyer may be sent to all participants of the auction via email or text, which ever method they choose. Auction item will be scheduled for shipment to the winning buyer. All buyers in present invention's auctions can earn extra bidding units by referring a friend that registers and participates in a future auction.

Limiting the buyers per predetermined auction keeps the auction process duration down to a predictable time frame, such as 15 minutes or less, for example by knowing the limited number of buyers, the allotted bid times, the start-up time, and the auction countdown time.

The determination of the registration fee, based on at least the seller's minimum selling price and the profit margin, wherein the registration fee is a function of the limited number of buyers to establish each predetermined auction, guarantees a profit for the seller and a known cost for each buyer when completing the auction process. Such a methodology fosters a win-win relationship for an auction of an item of any value, making it inexpensive to participate in. Also, the present invention levels the playing field, so as to be competitive through the game-playing, as opposed to a dollar-based competition, so as to not scare off some likely auction participants afraid of wasting their time when being outbid by another participant with a greater willingness to spend money.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for providing an online auction, comprising:
a computer having a user interface; and
a program product comprising machine-readable program code for causing, when executed, the computer to perform the following process steps:
prompting a seller to set auction parameters for the online auction via the user interface, wherein the auction parameters comprise:
at least one auction item;
a minimum selling price for each auction item; and
a limited number of bidders;
producing an electronic representation of an auction hall corresponding to each auction item, wherein the auction hall is configured to provide a bidding system;
prompting a plurality of bidders to each pay a registration fee for a predetermined auction item;
setting a scoring format for at least one online game;
prompting the plurality of bidders to play the at least one online game;
rewarding bidding units to the plurality of bidders based at least in part on the scoring format; and
electronically interconnecting the plurality of bidders and the auction hall for said predetermined auction item, wherein the bidding system for said predetermined auction item is based on the bidding units rewarded for playing the online game.

2. The system of claim 1, wherein the registration fee is calculated as the minimum selling price divided by the limited number of bidders.

3. The system of claim 1, wherein the auction parameters further comprise a profit margin for each auction item.

4. The system of claim 3, wherein the registration fee is calculated as a sum of the minimum selling price and the profit margin divided by the limited number of bidders.

5. The system of claim 1, wherein the auction parameters further comprise a start-up time.

6. The system of claim 5, wherein the electronically interconnecting of the plurality of bidders and the auction hall auction happens after the start-up time lapses, wherein the start-up time initiates when the limited number of bidders are prompted to play the at least one online game.

7. The system of claim 1, wherein the auction parameters further comprise an allotted bid time.

8. The system of claim 7, wherein the bidding system terminates if there is no bid within the allotted bid time.

9. The system of claim 1, wherein the auction parameters further comprise an auction countdown.

10. The system of claim 9, wherein the electronically interconnecting of the plurality of bidders and the auction hall auction happens after the auction countdown lapses, wherein the auction countdown initiates after the producing of the electronic representation of the auction hall.
